(19) United States
(12) Patent Application Publication
(10) Pub. No.: US 2014/0046784 A1
(43) Pub. Date: Feb. 13, 2014

(54) METHOD AND SYSTEM FOR MANAGING MULTIPLE ELECTRONIC USER WALLET DATA CARDS

(71) Applicants: Gyan Prakash, Beaverton, OR (US); Nagasubramanian Gurumoorthy, Portland, OR (US)

(72) Inventors: Gyan Prakash, Beaverton, OR (US); Nagasubramanian Gurumoorthy, Portland, OR (US)

(21) Appl. No.: 13/977,208

(22) PCT Filed: Dec. 29, 2011
(86) PCT No.: PCT/US11/67803

§ 371 Date: Jun. 28, 2013

(51) Int. Cl. G06Q 20/34

(52) U.S. Cl. CPC G06Q 20/3572; G06Q 20/352
USPC 705/17

(57) ABSTRACT

A method and device for managing and storing a plurality of electronic gift cards for use during a payment transaction includes receiving electronic information corresponding to a plurality of gift cards and securely storing the information in storage of a smartcard device as electronic gift cards. The smartcard device may monitor for a request to selectively activate an electronic gift card of the plurality of electronic gift cards for use during a payment transaction. The smartcard device may receive and transmit information corresponding to a selected electronic gift card using a near-field communication (NFC) data exchange.

### BACKGROUND

Gift cards have become a popular gift item amongst consumers because they offer a convenient mechanism for purchasing goods and services without requiring the physical transfer of paper money to a retail merchant. As such, gift cards are becoming ubiquitous in everyday life, so much so that an increasing number of retail merchants are offering them for sale. However, many of the gift cards sold by retail merchants are only accepted at specific retail locations operated by the merchant. That is, a gift card associated with one retail merchant is typically not usable in a retail location of another retail merchant. As a result, consumers may be forced to manage and carry multiple physical gift cards in their wallet, which can be cumbersome and time-consuming.

In addition to gift cards, consumers are carrying an increasing amount of information in their wallets. For example, a consumer may carry one or more physical identification cards, health insurance cards, membership cards, loyalty program cards, boarding passes, electronic tickets, debit cards, credit cards, pre-paid phone cards, and/or any other information needed by a consumer. Managing this information can also be cumbersome and time-consuming.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for storing and managing multiple electronic gift cards;

FIG. 2 is a simplified block diagram of at least one embodiment of a smartcard of the system of FIG. 1;

FIG. 3 is a simplified block diagram of at least one embodiment of a software environment of the smartcard of FIGS. 1 and 2;

FIG. 4 is a simplified flow diagram of at least one embodiment of a method for transferring a newly purchased electronic gift card to the smartcard of FIGS. 1-3; and

FIG. 5 is a simplified block diagram of at least one embodiment of a method for selecting and using an electronic gift card stored on the smartcard of FIGS. 1-3 in a payment transaction.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

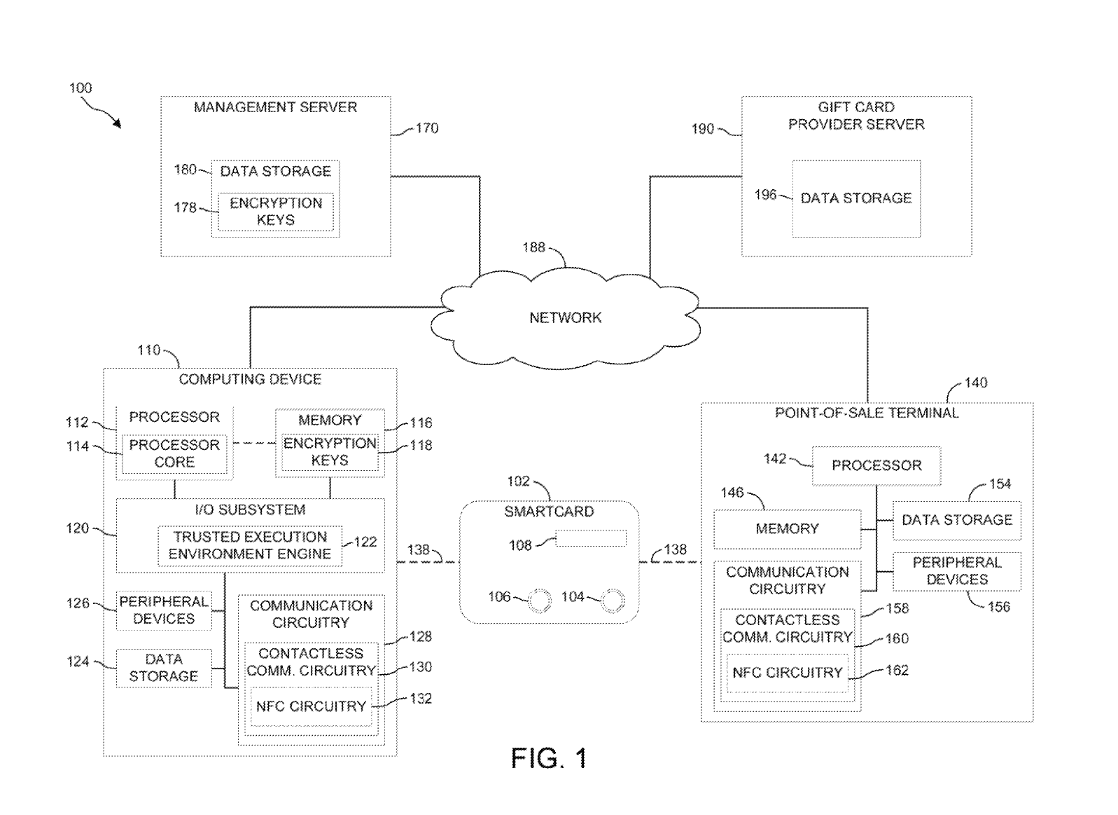

Referring now to FIG. 1, a system 100 for managing multiple electronic gift cards includes a smartcard device 102 configured to manage and store a plurality of electronic gift cards for use during a payment transaction. To do so, as discussed in more detail below, the smartcard device 102 may receive information corresponding to a gift card purchased by a user. The information may be received from a computing device 110 or a point-of-sale (PoS) terminal 140 using a contactless communication mechanism and stored in a secure storage of the smartcard device 102 as an electronic gift card. In operation, the smartcard device 102 may store a plurality of electronic gift cards in the secure storage. An electronic gift card may be selectively activated for use by a user of the smartcard device 102 from amongst the plurality of electronic gift cards stored in the secure storage. Upon determining that a user has selectively activated an electronic gift card from amongst the plurality of electronic gift cards, the smartcard device 102 may transmit information corresponding to the selected electronic gift card to a PoS terminal 140 using a contactless communication mechanism 130 to transact a payment or other transaction.

It should be understood that although the smartcard device 102 in the illustrative embodiment of FIG. 1 is configured to manage and store a plurality of electronic gift cards, the smartcard device 102 may also be configured to manage and store other types of information. In one embodiment, the smartcard device 102 may, additionally or alternatively, be configured to manage and store one or more wallet data cards. For example, the smartcard device may store and manage an electronic version of one or more physical identification cards, health insurance cards, membership cards, loyalty program cards, boarding passes, electronic tickets, debit cards, credit cards, pre-paid phone cards, and/or any other information needed by the user. In such embodiments, the smartcard device 102 may receive information corresponding to a wallet data card from the computing device 110 or the point-of-sale (PoS) terminal 140 using the contactless communication mechanism. The received wallet data information may then be stored in the secure storage of the smartcard device 102 as an electronic wallet data card.

The smartcard device 102 may be embodied as any type of smartcard device capable of performing the functions described herein. For example, the smartcard device 102 may be embodied as a smart card, an integrated circuit card, a chip card, or other computing device having a small form factor and embedded circuitry for storing a plurality of electronic gift cards. It should be understood that although the smartcard device 102 is embodied as a smart card having a small form factor in the illustrative embodiment of FIG. 1, the smartcard device 102 may be embodied as other types of computing devices in other embodiments. For example, the smartcard device 102 may be embodied as, or otherwise included in, a desktop computer, a laptop computer, a tablet computer, a mobile internet device, a handheld computer, a tablet computer, a smart phone, a personal digital assistant, a telephony device, or other computing device. In the illustrative embodiment of FIG. 1, the smartcard device 102 includes a display 108, a next card selection push-button switch 104, and a card activation push-button switch 106. Of course, the smartcard device 102 may include additional input and/or output devices (e.g., additional user buttons) in other embodiments. For example, in one embodiment wherein the smartcard device 102 is embodied as a smart phone, the smartcard device 102 may comprise an interactive user interface in place of or in addition to one or more of the display 108, the next card selection push-button switch 104, and the card activation push-button switch 106,

The computing device 110 may be embodied as any type of computing device capable of performing the functions described herein. For example, the computing device 110 may be embodied as a desktop computer, a laptop computer, a tablet computer, a mobile internet device, a handheld computer, a tablet computer, a smart phone, a personal digital assistant, a telephony device, or other computing device. In the illustrative embodiment of FIG. 1, the computing device 110 includes a processor 112, an I/O subsystem 120, a memory 116, a data storage device 124, and one or more peripheral devices 126. In some embodiments, several of the foregoing components may be incorporated on a motherboard of the computing device 110, while other components may be communicatively coupled to the motherboard via, for example, a peripheral port. Furthermore, it should be appreciated that the computing device 110 may include other components, sub-components, and devices commonly found in a computer and/or computing device, which are not illustrated in FIG. 1 for clarity of the description.

The processor 112 of the computing device 110 may be embodied as any type of processor capable of executing software/firmware, such as a microprocessor, digital signal processor, microcontroller, or the like. The processor 112 is illustratively embodied as a single core processor having a processor core 114. However, in other embodiments, the processor 112 may be embodied as a multi-core processor having multiple processor cores 114. Additionally, the computing device 110 may include additional processors 112 having one or more processor cores 114.

The I/O subsystem 120 of the computing device 110 may be embodied as circuitry and/or components to facilitate input/output operations with the processor 112 and/or other components of the computing device 110. In some embodiments, the I/O subsystem 120 may be embodied as a memory controller hub (MCH or “northbridge”), an input/output controller hub (ICH or “southbridge”), and a firmware device. In such embodiments, the firmware device of the I/O subsystem 120 may be embodied as a memory device for storing Basic Input/Output System (BIOS) data and/or instructions and/or other information (e.g., a BIOS driver used during booting of the computing device 110). However, in other embodiments, I/O subsystems 120 having other configurations may be used. For example, in some embodiments, the I/O subsystem 120 may be embodied as a platform controller hub (PCH). In such embodiments, the memory controller hub (MCH) may be incorporated in or otherwise associated with the processor 112, and the processor 112 may communicate directly with the memory 116 (as shown by the hashed line in FIG. 1). Additionally, in other embodiments, the I/O subsystem 120 may form a portion of a system-on-a-chip (SoC) and be incorporated, along with the processor 112 and other components of the computing device 110, on a single integrated circuit chip.

In some embodiments, the I/O subsystem 120 may include a Trusted Execution Environment (TEE) engine 122, which may be embodied as an embedded microprocessor, such as a security co-processor, that operates independently of the processor 112 to provide a secure and isolated environment that cannot be accessed by the processor 112 or other components of the computing device 110. In some embodiments, the TEE engine 122 may manage the storage of one or more encryption keys 118 used by the computing device 110 to secure data and or communications between the computing device 110 and a management server 170 and/or a gift card provider server 190. In such embodiments, the one or more encryption keys 118 may be stored in a portion of the memory 116 that is accessible to the TEE engine 122 but inaccessible to other components of the computing device 110. In other embodiments, the TEE engine 122 may include internal or local secured memory, separate from the memory 116, in which the encryption keys 118 may be stored. Additionally, in some embodiments, the TEE engine 122 may generate a one-time password (OTP), which may be utilized to facilitate two-factor authentication procedures.

The processor 112 is communicatively coupled to the I/O subsystem 120 via a number of signal paths. These signal paths (and other signal paths illustrated in FIG. 1) may be embodied as any type of signal paths capable of facilitating communication between the components of the computing device 110. For example, the signal paths may be embodied as any number of wires, cables, light guides, printed circuit board traces, via, bus, link, interconnect, intervening devices, and/or the like.

The memory 116 of the computing device 110 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 116 is communicatively coupled to the I/O subsystem 120 via a number of signal paths. Although only a single memory device 116 is illustrated in FIG. 1, the computing device 110 may include additional memory devices in other embodiments. Various data and software may be stored in the memory device 116. For example, one or more operating systems, applications, programs, libraries, and drivers that make up the software stack executed by the processor 112 may reside in memory 116 during execution. Furthermore, software and data stored in memory 116 may be swapped between the memory 116 and the data storage device 124 as part of memory management operations.

The peripheral devices 126 of the computing device 110 may include any number of peripheral or interface devices. For example, the peripheral devices 126 may include a display, a touch screen, a keyboard, a mouse, external speakers, and/or other peripheral devices. Additionally, the peripheral devices 126 may include communication circuitry 128 to facilitate communication with one or more remote computing devices over a network 188. The computing device 110 may use any suitable communication protocol to communicate with other computing devices over the network 188 depending on, for example, the particular type of network(s) 188.

The communication circuitry 128 may also include a contactless communication mechanism 130 such as near-field communication (NFC) circuitry 132 in some embodiments. The computing device 110 may use the NFC circuitry 132 to transmit and/or receive data to/from one or more remote computing devices without using the network 188. For example, the computing device 110 may use NFC data exchanges 138 to transfer data to/from the smartcard device 102, which as discussed below, may also include NFC circuitry. It should be understood that although the contactless communication circuitry 130 of the computing device 110 is embodied as the NFC circuitry 132 in the illustrative embodiment, the contactless communication circuitry 130 may be embodied as, or otherwise include, other types of contactless communication mechanisms for transferring data to/from the smartcard device 102 in other embodiments. For example, the contactless communication circuitry 130 of the computing device 110 may be embodied as Bluetooth® circuitry or any other short-range communication circuitry suitable for use in communicating with the smartcard device 102.

The peripheral devices 126 of the computing device may also include data storage device(s) 124. The data storage device(s) 124 may be embodied as any type of device or devices configured for the short-term or long-term storage of data such as, for example, memory devices and circuits, memory cards, hard disk drives, solid-state drives, or other data storage devices. The particular devices included in the peripheral devices 126 may depend upon, for example, the intended use of the computing device 110. The peripheral devices 126 are communicatively coupled to the I/O subsystem 120 via a number of signal paths thereby allowing the I/O subsystem 120 and/or processor 112 to receive inputs from and send outputs to the peripheral devices 126.

The point-of-sale (PoS) terminal 140 may be embodied as any type of computing device capable of conducting a sales transaction and performing other functions described herein. For example, the PoS terminal 140 may be a retail or wholesale computer, which may be embodied as a desktop computer, a laptop computer, a tablet computer, a mobile interact device, a handheld computer, a smart phone, a personal digital assistant, a telephony device, or other computing device. In the illustrative embodiment of FIG. 1, the PoS terminal 140 includes components similar to the computing device 110 such as a processor 142, a memory 146, a data storage device 154, and one or more peripheral devices 156. In some embodiments, the PoS terminal 140 may include an I/O subsystem similar to the I/O subsystem 120 of the computing device 110. Additionally, in some embodiments, several of the foregoing components may be incorporated on a motherboard of the PoS terminal 140, while other components may be communicatively coupled to the motherboard via, for example, a peripheral port. Furthermore, it should be appreciated that the PoS terminal 140 may include other components, sub-components, and devices commonly found in a computer and/or computing device, which are not illustrated in FIG. 1 for clarity of the description.

The processor 142 of the PoS terminal 140 may be embodied as any type of processor capable of executing software/firmware, such as a microprocessor, digital signal processor, microcontroller, or the like. The processor 142 is illustratively embodied as a single core processor having a processor core. However, in other embodiments, the processor 142 may be embodied as a multi-core processor having multiple processor cores. Additionally, the PoS terminal 140 may include additional processors 142 having one or more processor cores.

The processor 142 is communicatively coupled to the components of the PoS terminal 140 via a number of signal paths. These signal paths (and other signal paths illustrated in FIG. 1) may be embodied as any type of signal paths capable of facilitating communication between the components of the PoS terminal 140. For example, the signal paths may be embodied as any number of wires, cables, light guides, printed circuit board traces, via, bus, intervening devices, and/or the like.

The memory 146 of the PoS terminal 140 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 146 is communicatively coupled to other components of the PoS terminal 140 via a number of signal paths. Although only a single memory device 146 is illustrated in FIG. 1, the PoS terminal 140 may include additional memory devices in other embodiments. Various data and software may be stored in the memory device 146. For example, one or more operating systems, applications, programs, libraries, and drivers that make up the software stack executed by the processor 142 may reside in memory 146 during execution. Furthermore, software and data stored in memory 146 may be swapped between the memory 146 and the data storage device 154 as part of memory management operations.

The peripheral devices 156 of the PoS terminal 140 may include any number of peripheral or interface devices. For example, the peripheral devices 156 may include a display, a touch screen, a keyboard, a mouse, external speakers, and/or other peripheral devices. Additionally, the peripheral devices 156 may include communication circuitry 158 to facilitate communication with one or more remote computing devices over a network 188. The PoS terminal 140 may use any suitable communication protocol to communicate with other computing devices over the network 188 depending on, for example, the particular type of network(s) 188. The PoS terminal 140 may use a contactless communication mechanism 160 such as the NFC circuitry 162 to transmit and/or receive data to/from one or more remote computing devices without using the network 188. For example, the PoS terminal 140 may use NFC data exchanges 138 to transfer data to/from the smartcard device 102, which as discussed below, may also include NFC circuitry. It should be understood that although the contactless communication circuitry 160 of the PoS terminal 140 is embodied as the NFC circuitry 162 in the illustrative embodiment, the contactless communication circuitry 160 may be embodied as, or otherwise include, other types of contactless communication mechanisms for transferring data to/from the smartcard device 102 in other embodiments. For example, the contactless communication circuitry 160 of the PoS terminal 140 may be embodied as Bluetooth® circuitry or any other short-range communication circuitry suitable for use in communicating with the smartcard device 102.

The peripheral devices 156 of the computing device may also include data storage device(s) 154. The data storage device(s) 154 may be embodied as any type of device or devices configured for the short-term or long-term storage of data such as, for example, memory devices and circuits, memory cards, hard disk drives, solid-state drives, or other data storage devices. In some embodiments, the data storage device(s) 154 may store one or more encryption keys used by the PoS terminal 140 to secure data and or communications between the PoS terminal 140 and one of more of the smartcard device 102, a management server 170, and/or a gift card provider server 190. The peripheral devices 156 are communicatively coupled to other components of the PoS terminal 140 via a number of signal paths thereby allowing the other components and/or the processor 142 to receive inputs from and send outputs to the peripheral devices 156.

The management server 170 may be embodied as any type of server capable of performing the gift card management functions described herein. The management server 170 may include various components typically found in a sever computer. In the illustrative embodiment of FIG. 1, the management server 170 includes a data storage device 180. The data storage device 180 may store one or more encryption keys 178 used by the management server 170 to secure data and or communications between the management server 170 and the computing device 110, the gift card provider server 190, and/or the PoS terminal 140. In some embodiments, the data storage device 180 may store a one-time password (OTP), which may be generated by management server 170 and utilized to facilitate two-factor authentication procedures.

The gift card provider server 190 may be embodied as any type server capable of performing the functions described below. Similar to the management server 170, the gift card provider server 190 may include various components typically found in a server computer. In the illustrative embodiment of FIG. 1, the gift card provider server 190 includes a data storage device 196 for storing gift card information corresponding to one or more purchased, complimentary, or preloaded gift cards. The data storage device 196 may also store one or more encryption keys used by the gift card provider server 190 to secure data and/or communications between the gift card provider server 190 and the computing device 110, the management server 170, and/or the PoS terminal 140. It should be appreciated that although the system 100 illustratively includes a single gift card provider server 190 in illustrative embodiment of FIG. 1, the system 100 may include additional gift card provider servers 190 or other types of information provider servers for storing electronic wallet data information in other embodiments.

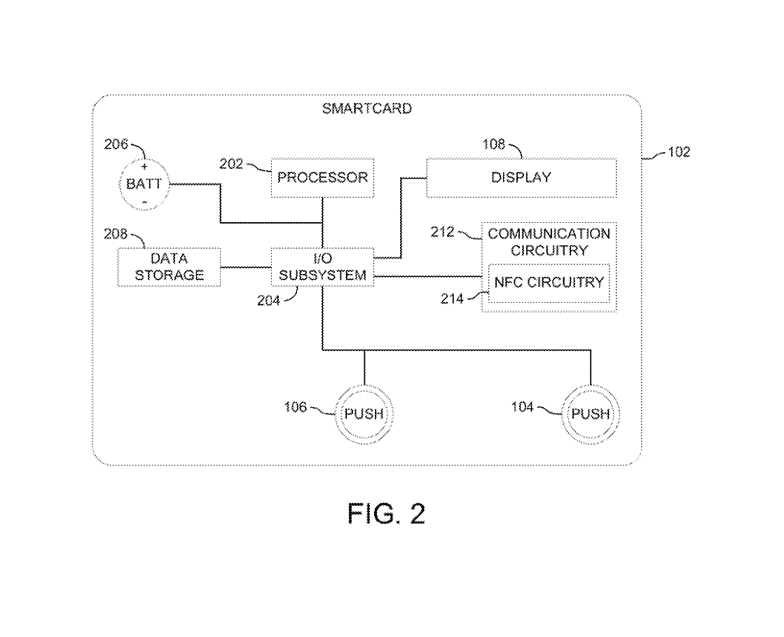

Referring now to FIG. 2, the smartcard device 102 may further include a processor 202, an I/O subsystem 204, a data storage device 208, a battery 206, and communication circuitry 212. In some embodiments, several of the foregoing components may be incorporated in circuitry of the smartcard device 102, while other components may be communicatively coupled to the circuitry via, for example, a peripheral port. Furthermore, it should be appreciated that the smartcard device 102 may include other components, sub-components, and devices commonly found in a smartcard device, which are not illustrated in FIG. 2 for clarity of the description.

The processor 202 of the smartcard device 102 may be embodied as any type of processor capable of executing software/firmware, such as a microprocessor, digital signal processor, microcontroller, or the like. The processor 202 is illustratively embodied as a single core processor having a processor core. However, in other embodiments, the processor 202 may be embodied as a multi-core processor having multiple processor cores. Additionally, the smartcard device 102 may include additional processors 202 having one or more processor cores.

The I/O subsystem 204 of the smartcard device 102 may be embodied as circuitry and/or components to facilitate input/output operations with the processor 202 and/or other components of the smartcard device 102. In some embodiments, the I/O subsystem 204 may be embodied as a memory controller hub (MCH or “northbridge”), an input/output controller hub (ICH or “southbridge”), and a firmware device. In such embodiments, the firmware device of the I/O subsystem 204 may be embodied as a memory device for storing Basic Input/Output System (BIOS) data and/or instructions and/or other information (e.g., a BIOS driver used during booting of the smartcard device 102). However, in other embodiments, I/O subsystems 204 having other configurations may be used. For example, in some embodiments, the I/O subsystem 204 may be embodied as a platform controller hub (PCH). In such embodiments, the memory controller hub (MCH) may be incorporated in or otherwise associated with the processor 202, and the processor 202 may communicate directly with other components of the smartcard device 102. Additionally, in one particular embodiment, the I/O subsystem 204 may form a portion of a system-on-a-chip (SoC) and be incorporated, along with the processor 202 and other components of the smartcard device 102, on a single integrated circuit chip.

The processor 202 is communicatively coupled to the I/O subsystem 204 via a number of signal paths. These signal paths (and other signal paths illustrated in FIG. 2) may be embodied as any type of signal paths capable of facilitating communication between the components of the smartcard device 102. For example, the signal paths may be embodied as any number of wires, cables, light guides, printed circuit board traces, via, bus, link, interconnect, intervening devices, and/or the like.

The communication circuitry 212 of the smartcard device 102 facilitates communication with one or more remote computing devices. In some embodiments, the communication circuitry 212 is embodied as or otherwise includes a contactless communication mechanism such as near-field communication (NFC) circuitry 214. The smartcard device 102 may use the NFC circuitry 214 to transmit and/or receive information directly to/from one or more remote computing devices. For example, the smartcard device 102 may use the NFC circuitry 214 to share information corresponding to an electronic gift card with the computing device 110 or the PoS terminal 140. In embodiments wherein the smartcard device 102 stores other types of information, the smartcard device may use the NFC circuitry 214 to share information corresponding to an electronic wallet data card with the computing device 110 or the PoS terminal 140, which may be embodied as an information access terminal.

The data storage device(s) 208 of the smartcard device 102 may be embodied as any type of device or devices configured for the short-term or long-term storage of data such as, for example, memory devices and circuits, memory cards, micro hard disk drives, solid-state drives, or other data storage devices. The data storage device(s) 208 may be used to securely store information corresponding to one or more electronic gift cards. For example, the data storage device(s) 208 may store electronic information corresponding to the date that a particular gift card was purchased, the expiration date of a gift card, the name of the retail merchant at which a gift card is redeemable, the original purchase amount of a gift card, the amount last used from a gift card, and the remaining balance of a gift card. Some of the electronic information stored in the data storage device 208 may be displayed on the display 108 to a user during operation of the smartcard device 102. For example, the name of the retail merchant at which a particular gift card is redeemable may be displayed to a user through the display 108. Additionally or alternatively, other information identifying a particular electronic gift card, such as an account or gift card number, may be displayed on the display 108 during use of the smartcard device 102.

As previously discussed, in some embodiments, the data storage device(s) 208 of the smartcard device 102 may also store other types of information. For example, the data storage device(s) 208 may, additionally or alternatively, be used to securely store one or more electronic wallet data cards, each of which may include an electronic version of one or more physical identification cards, health insurance cards, membership cards, loyalty program cards, boarding passes, electronic tickets, debit cards, credit cards, pre-paid phone cards, and/or any other information needed by the user. During use of the smartcard device 102, some of the information corresponding to the electronic wallet data cards may also be displayed to the user through the display 108. For example, a driver's license number or a frequent flyer account number may be displayed to the user through the display 108.

A user may interact with the smartcard device 102 via the push-button switches 104, 106. In the illustrative embodiment, the push-button switches 104, 106 are embodied as physical push-button switches. However, in other embodiments, the push-button switches 104. 106 may be embodied as “soft” switches, capacitive or resistive switches, other electrical-type switches, non-mechanical switches, or other buttons, switches, or other appropriate circuitry usable by a user to interact with the smartcard device 102. For example, when interacted with by a user of the smartcard device 102, the next card selection push-button switch 104 generates a signal indicative of a request to display information corresponding to another electronic gift card stored in the data storage device(s) 208. Additionally, the card activation push-button switch 106, when interacted with by a user of the smartcard device 102, generates a signal indicative of a request to activate the currently displayed electronic gift card for use in a payment transaction. Of course, it should be appreciated that in some embodiments, the user may interact with the smartcard device 102 using devices or interfaces different from, or in addition to, the push-button switches 104, 106. For example, in embodiments wherein the smartcard device 102 is embodied as (or embedded within) a smart phone, the user may interact with one or more user interfaces (e.g. apps, user-selection screens, windows, icons, etc.) generated and/or displayed by the smart phone.

As discussed above, the smartcard device 102 is configured to store and manage a plurality of electronic gift cards for use during a payment transaction. In operation, the NFC circuitry 214 of the smartcard device 102 may receive information corresponding to a purchased, complimentary, or preloaded gift card from the computing device 110. The information received may correspond to a newly purchased gift card or to a previously purchased, complimentary, or preloaded gift card. Regardless, once received by the NFC circuitry 214, the smartcard device 102 securely stores the information in the data storage device 208 as an electronic gift card.

In some embodiments, as discussed above, a user may interact with one or more push-button switches or other inputs on the smartcard device 102 to select a specific electronic gift card from the plurality of electronic gift cards for use during a particular payment transaction. For example, the smartcard device 102 illustratively includes the next card selection push-button 104 to enable the user to selectively choose one electronic gift card of the plurality of electronic gift cards for use during a payment transaction. The smartcard device 102 also includes the card activation push-button 106 to enable the user to activate the selected gift card for use during a payment transaction. As discussed above, it should be understood that the smartcard device 102 may include mechanisms other than push-button switches for selecting and using a specific electronic gift card. For example, in some embodiments, the smartcard device 102 may generate a menu including a selectable list comprising one or more of the plurality of electronic gift cards stored on the smartcard device 102.

In response to a user selecting and activating an electronic gift card using the push-button switches 104, 106, the smartcard device 102 may retrieve the information corresponding to the selected electronic gift card from the data storage device 208 and, thereafter, transmit the retrieved information to the PoS terminal 140 using the NFC circuitry 214 to complete a payment transaction. For example, the smartcard device 102 may retrieve an account number associated with the selected electronic gift card from the data storage device 208 and subsequently transfer the account number to the PoS terminal 140, along with any additional information required to complete the payment transaction.

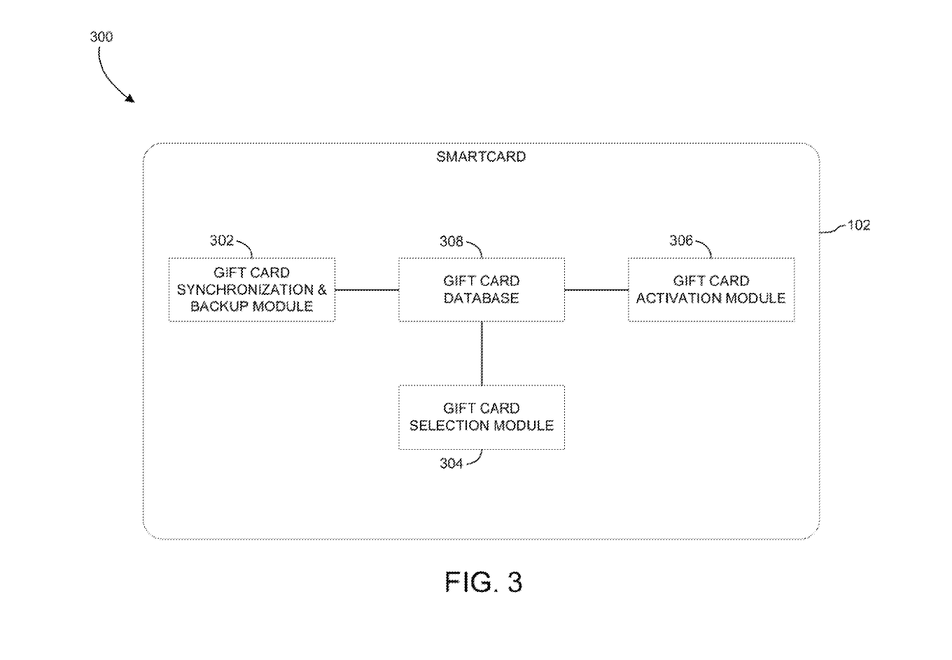

Referring now to FIG. 3, one embodiment of a software environment 300 of the smartcard device 102 includes a gift card database 308, a gift card synchronization and backup module 302, a gift card selection module 304, and a gift card activation module 306. Of course, it should be appreciated that the smartcard device 102 may include other components, sub-components, modules, and devices commonly found in a smartcard device, which are not illustrated in FIG. 3 for clarity of the description.

The gift card database 308 may be stored in the data storage device 208 of the smartcard device 102 and securely store electronic gift card information. In some embodiments, the gift card database 308 may be embodied as or otherwise include one or more tables to store electronic gift card information corresponding to each electronic gift card stored in the data storage device 208.

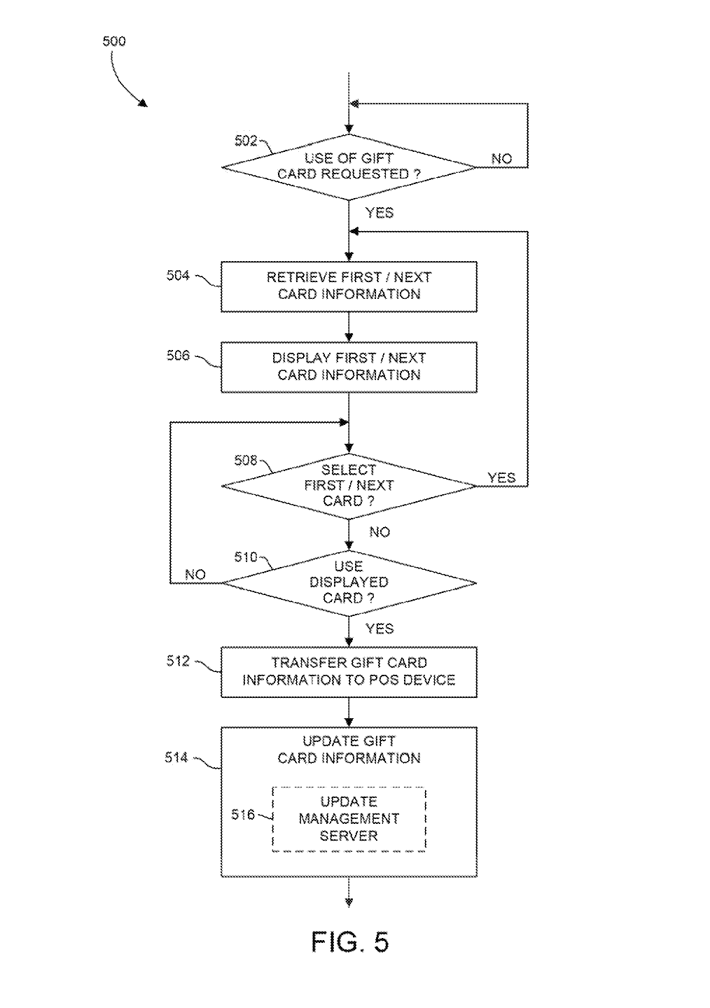

As discussed above, the smartcard device 102 includes a gift card selection module 304 for detecting whether a user desires to select another electronic gift card for use during a payment transaction. In use, the gift card selection module 304 detects interaction with the next card selection push-button 104 (or other input device) to determine that the user desires to select a different electronic gift card for use during a payment transaction. If so, the gift card selection module 304 access the gift card database 308 to retrieve electronic gift card information associated with the different electronic gift card and, in some embodiments, displays identification data (e.g., the merchant's name) on the display 108 as discussed in more detail below with regard to FIG. 5.

Additionally, as discussed above, the smartcard device 102 includes a gift card activation module 306 for detecting whether a user desires to activate a currently selected electronic gift card for use during a payment transaction. In use, the gift card activation module 306 detects interaction with the card activation push-button 106 to determine that the user desires to use the currently selected electronic gift card during a payment transaction. If so, the gift card activation module 306 is configured to transmit the electronic gift card information associated with the selected electronic gift card to the PoS terminal 140 as discussed below. Additionally, in order to reduce the likelihood of a malicious third party intercepting information associated with the selected electronic gift card, the gift card activation module 306 may, in some embodiments, only activate the selected electronic gift card for use during a reference period of time (e.g., for some period of time after selection of the electronic gift card). Upon expiration of the reference period of time, the gift card activation module 306 may deactivate the selected electronic gift card and require its reselection. Of course, additional security devices and methodologies may be used in some embodiments to increase the security for the smartcard device 102. For example, the user may be required to press the push-button switches 104, 106 according to a reference sequence in order to activate the selected gift card. In other embodiments, the smartcard device may comprise additional modules and/or components to further reduce the likelihood of a malicious third party intercepting information associated with the selected electronic gift card. For example, in embodiments wherein Bluetooth® circuitry is used to transfer information to/from the smartcard device 102 and the computing device 110 and/or the PoS terminal 140, the communications therebetween may be encrypted via one or more encryption keys. In other embodiments, one or more forms of authentication may be required before information may be exchanged. For example, in embodiments wherein the smartcard device 102 is embodied as a smart phone, the user may be required to correctly enter a password and/or a PIN on a keypad of the smart phone before electronic gift card information is exchanged.

The gift card database 308 is also be communicatively coupled to the gift card synchronization and backup module 302 to facilitate reloading electronic gift cards and/or updating information corresponding to electronic gift cards after completion of a payment transaction. To do so, the gift card synchronization and backup module 302 may transmit and/or receive updated electronic gift card information from the computing device 110 or the PoS terminal 140 via NFC data exchanges 138. Upon receiving updated electronic gift card information corresponding to an electronic gift card stored on the smartcard device 102, the gift card synchronization and backup module 302 may update the appropriate information corresponding to the electronic gift card.

Additionally, the gift card synchronization and backup module 302 may receive electronic gift card information corresponding to a newly purchased gift card or a previously purchased, complimentary, or preloaded gift card from the gift card provider server 190. To do so, the computing device 110 and/or the PoS terminal 140 may be used as a proxy between the gift card provider server 190 and the gift card synchronization and backup module 302. In operation, the gift card provider server 190 transmits electronic gift card information corresponding to the newly purchased, previously purchased, complimentary, or preloaded gift card to the computing device 110 and/or the PoS terminal 140 over a communication network 188 (see FIG. 1). In turn, the gift card synchronization and backup module 302 of the smartcard device 102 receives the electronic gift card information corresponding to the newly purchased gift card from the computing device 110 and/or the PoS terminal 140 through an NFC data exchange 138. In some embodiments, upon receipt of the electronic gift card information corresponding to the newly purchased, previously purchased, complimentary, or preloaded gift card, the gift card synchronization and backup module 302 securely stores the information in the data storage device 208 of the smartcard device 102.

In some embodiments, the gift card synchronization and backup module 302 may also transmits backup information corresponding to one or more of the stored electronic gift cards to the management server 170 using the computing device 110 as a proxy. In operation, the gift card synchronization and backup module 302 transmits the backup information to the computing device 110 through an NFC data exchange 138. In turn, the computing device 110 transmits the backup information to the management server 170 over a communication network 188. Of course, it should be appreciated that in some embodiments, electronic gift card information corresponding to one or more of the electronic gift cards backed up on the management server 170 can be restored on the smartcard device 102. In such embodiments, the backup information or a portion thereof may be transmitted to the computing device 110 over the network 188. Thereafter, the computing device 110 may transfer the backup information to the smartcard device 102 using one or more NFC data exchanges 138. Upon receiving the backup information, the smartcard device 102 may restore one or more of the backed up electronic gift cards.

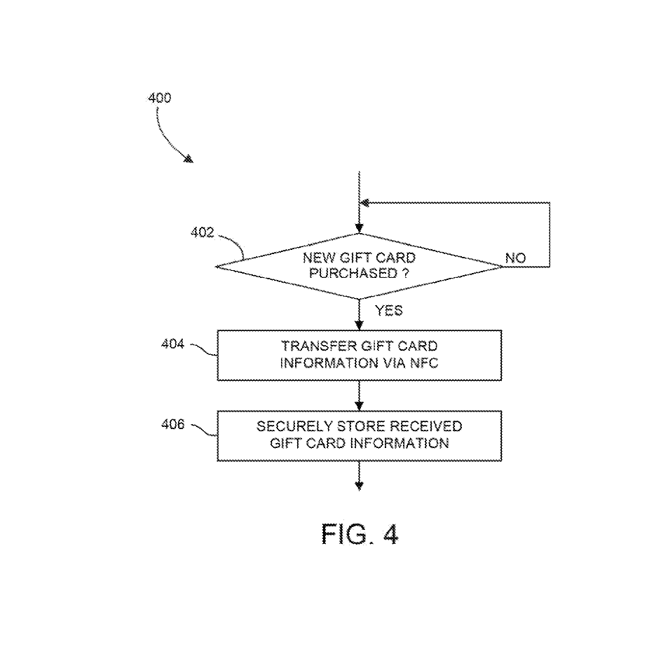

Referring now to FIG. 4, a method 400 for transferring electronic gift card information of a newly purchased gift card to the smartcard device 102 for storage begins with block 402. In block 402, the computing device 110 determines whether a new gift card has been purchased. The computing device 110 may determine that a new gift card has been purchased based on communications from the gift card provider server 190, data entered into the computing device 110 by a user, and/or the like. For example, in an embodiment, the user may purchase a physical gift card comprising a redemption code from a retail outlet. In such embodiments, the redemption code may be entered on the computing device 110 (e.g., through a website, application, etc.) and transmitted to the gift card provider server 190 via the network 188. In response, the gift card provider server 190 may validate the redemption code and transmit electronic information corresponding to the physical gift card to the computing device 110. If the computing device 110 determines that a new gift card has been purchased, the method 400 advances to block 404.

In block 404, electronic information corresponding to the newly purchased gift card is transferred from the computing device 110 to the smartcard device 102 using an NFC data exchange 138. For example, in some embodiments, the NFC circuitry 132 of the computing device 110 may transfer electronic gift card information to the NFC circuitry 214 of the smartcard device 102. The electronic gift card information transferred by the NFC circuitry 132 may be previously stored in the data storage device 124 of the computing device 110. Additionally or alternatively, the electronic gift card information transferred by the NFC circuitry 132 may first be received by the communication circuitry 128 of the computing device 110. For example, the communication circuitry 128 may first receive the electronic gift card information from the management server 170 and/or the gift card provider server 190 via the network 188. In some embodiments, the computing device 110 may use one or more encryption keys 118 to secure data and/or communications with the management server 170 over the network 188.

In block 406, the smartcard device 102 securely stores the electronic gift card information in a secure storage as an electronic gift card. For example, the smartcard device 102 may store the received electronic gift card information in a secure portion of the data storage device 208. As discussed above, the data storage device 208 of the smartcard device 102 may store a plurality of electronic gift cards available for use by a user. Additionally or alternatively, in other embodiments, the smartcard device 102 may generate a one-time password (OTP), which may be utilized to facilitate two-factor authentication procedures with computing device 110, the PoS terminal 140, the management server 170, and/or the gift card provider server 190.

Referring now to FIG. 5, a method 500 for selecting and using an electronic gift card stored on the smartcard device 102 begins with block 502. In block 502, the smartcard device 102 determines whether use of an electronic gift card is desired. To do so, the smartcard device 102 may determine whether a user has interacted with one or more push-button switches of the smartcard device 102. If so, the method 500 advances to block 504.

In block 504, the smartcard device 102 retrieves electronic gift card information corresponding to a first electronic gift card of the plurality of electronic gift cards stored in the data storage device 208. For example, the smartcard device 102 may retrieve electronic gift card information corresponding to the date that the first gift card was purchased, the expiration date of the first gift card, the name of the retail merchant at which the first gift card is redeemable, the original purchase amount of the first gift card, the amount last used from the first gift card, and the remaining balance of the first gift card. It should be understood that in some embodiments, the first electronic gift card may be a default electronic gift card pre-selected by a user. Alternatively, the first electronic gift card may be based on other criteria such as the name of the retail merchant, the level of usage of the electronic gift card, prior user behavior, and/or other criteria useful in selecting one of the stored electric gift cards as the first electronic gift card. For example, in some embodiments the smartcard device 102 may include one or more components for determining a location of the smartcard device 102. In such embodiments, the smartcard device 102 may receive signals (e.g., Global Positional System (GPS) signals, store broadcast signals, Wi-Fi Access Point beacons, etc.) indicative of the location (e.g., latitude and longitude, city, state, zip, retail merchant, etc.) of the smartcard device 102. Based on the location of the smartcard device 102, the first electronic gift card may comprise the electronic gift card corresponding to the determined location (e.g., the specific retail store). Once the electronic gift card information corresponding to the first electronic gift card has been retrieved from the data storage device 208, the method 500 advances to block 506.

In block 506, the smartcard device 102 displays the retrieved electronic gift card information, or a portion thereof, corresponding to the first electronic gift card on a display 108 of the smartcard device 102. For example, in some embodiments, the smartcard device 102 may retrieve and display information that identifies the name of the retail merchant at which the first gift card is redeemable or other information capable of identifying the selected electronic gift card. Additionally or alternatively, the smartcard device 102 may display the amount of credit remaining on the selected electronic gift card (e.g., the name of the retail merchant and remaining credit balance may be displayed in a scrolling or alternating fashion).

In block 508, the smartcard device 102 determines whether the user desires to advance to the next electronic gift card of the plurality of electronic gift cards stored in the data storage device 208. To do so, the gift card selection module 304 of the smartcard device 102 may determine whether the user interacted with a push-button switch 104 on the smartcard device 102 corresponding to a request to advance to the next electronic gift card. For example, in some embodiments, a signal may be generated upon the interaction with a next card selection push-button 104 by a user. The signal may then be detected by the gift card selection module 304 of the smartcard device 102.

If, in block 508, the smartcard device 102 determines that the next card selection push-button 104 has been interacted with by the user, the method 500 proceeds back to block 504 in which the smartcard device 102 executes blocks 504, 506, and 508 for the next stored electronic gift card of the plurality of electronic gift cards each time the next card selection push-button 104 is interacted with.

However, if the smartcard device 102 determines that the next card selection push-button 104 has not been interacted with by the user, the method 500 proceeds to block 510 in which the smartcard device 102 determines whether the user desires to activate the electronic gift card corresponding to the electronic gift card information currently being displayed for use in a payment transaction. To do so, the gift card activation module 306 of the smartcard device 102 may determine whether the user interacted with a push-button switch 106 on the smartcard device 102 corresponding to a request to activate the currently displayed electronic gift card for use in a payment transaction. For example, in some embodiments, a signal may be generated upon interaction with the card activation push-button 106 by a user. The signal may then be detected by gift card activation module 306 of the smartcard device 102 and the method 500 advances to block 512. Of course, it should be understood that in some embodiments, blocks 508 and 510 may be executed in either order or the smartcard device 102 may execute both blocks 508 and 510 contemporaneously.

In block 512, the smartcard device 102 transfers the electronic gift card information corresponding to the selected electronic gift card to the PoS terminal 140 using an NFC data exchange 138. For example, the NFC circuitry 214 of the smartcard device 102 may transmit the electronic gift card information to the NFC circuitry 162 of the PoS terminal 140 to complete the payment transaction. In some embodiments, the smartcard device 102 may transfer the account number associated with the selected electronic gift card, and/or other data of the associated electronic gift card information, to the PoS terminal 140. Upon transferring the electronic gift card information to the PoS terminal 140, the method 500 advances to block 514.

In block 514, the smartcard device 102 may receive updated electronic gift card information corresponding to the electronic gift card used in the payment transaction via an NFC data exchange 138. For example, in some embodiments, the smartcard device 102 may receive information from the PoS terminal 140 corresponding to an amount that the remaining balance of the particular electronic gift card used should be reduced. Upon receipt of the updated electronic gift card information, the smartcard device 102 may update the appropriate electronic gift card information stored in the data storage device 208.

Additionally or alternatively, the PoS terminal 140 may transmit updated electronic gift card information corresponding to the electronic gift card used in the payment transaction to the management server 170 and/or the gift card provider server 190 to be synchronized. In some embodiments, the computing device 110 may also forward the updated electronic gift card information to the management server 170 over the network 188. In such embodiments, the computing device 110 may use one or more encryption keys 118 to secure data and/or communications with the management server 170 over the network 188. Regardless, upon receipt of the updated electronic gift card information, the management server 170 and/or the gift card provider server 190 may update the appropriate electronic gift card information stored in the data storage devices 180, 196. Thereafter, the updated electronic gift card information (e.g., a remaining balance, payment transaction history, a refill amount, etc.) may be made available to be transferred to the smartcard device 102.

Additionally, in some embodiments, the smartcard device 102 may transfer updated electronic gift card information to the management server 170 to be synchronized. To do so, the smartcard device 102 may first transfer the updated electronic gift card information to the computing device 110 using one or more NFC data exchanges 138. Thereafter, the computing device 110 may forward the updated electronic gift card information to the management server 170 over the network 188. Upon receipt of the updated electronic gift card information, the management server 170 may update the appropriate electronic gift card information stored in the data storage device 180. In other embodiments, the smartcard device 102 may generate a one-time password (OTP), which may be utilized to facilitate two-factor authentication procedures with the computing device 10, the PoS terminal 140, the management server 170, and/or the gift card provider server 190. In such embodiments, one or more of the PoS terminal 140, the management server 170, and/or the gift card provider server 190 may generate a corresponding OTP.

Additionally, in embodiments wherein the smartcard device 102 is also configured to manage and store other types of information such as, for example, one or more wallet data cards, the smartcard device 102 may comprise components and/or functionality similar to that discussed above with reference to the electronic gift cards of FIGS. 1-5. For example, with reference to the smartcard device 102 shown in the illustrative embodiment of FIG. 3, the gift card database 308, the gift card synchronization and backup module 302, the gift card selection module 304, and the gift card activation module 306 may instead be embodied as a wallet card database 308, a wallet card synchronization and backup module 302, a wallet card selection module 304, and a wallet card activation module 306, respectively. Such modules may store information corresponding to a variety of different types of electronic information cards (electronic gift cards, electronic wallet data cards, etc.) and provide similar functionality.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

### EXAMPLES

Example 1 includes subject matter (such as a system, apparatus, a device, etc.) comprising a wallet card synchronization and backup module to receive electronic card information from a computing device using a contactless communication mechanism, the electronic card information corresponds to a purchased, complimentary, or preloaded gift card; a wallet card database to store the electronic card information corresponding to the purchased, complimentary, or preloaded gift card as an electronic wallet card, the wallet card database to store a plurality of electronic wallet cards; a wallet card selection module to receive a selection of one of the plurality of electronic wallet cards stored in the wallet card database; and a wallet card activation module to transfer the electronic card information corresponding to the selected electronic wallet card to a point-of-sale device using the contactless communication mechanism for a payment transaction.

In Example 2, the subject matter of Example 1 in which the apparatus optionally comprises a smartcard.

In Example 3, the subject matter of any of Examples 1 or 2 in which the apparatus optionally comprises one of a smart phone, mobile internet device, portable digital assistant, or tablet computer.

In Example 4, the subject matter of any of Examples 1-3 in which the contactless communication mechanism comprises near-field communication (NFC) circuitry.

In Example 5, the subject matter of any of Examples 1-4 in which the contactless communication mechanism comprises Bluetooth circuitry.

In Example 6, the subject matter of any of Examples 1-5 in which the wallet card synchronization and backup module is optionally to receive at least one of an account number, a purchase date, an expiration date, a merchant name, a purchase amount, an amount last used, and a remaining balance corresponding to the purchased, complimentary, or preloaded gift card.

In Example 7, the subject matter of any of Examples 1-6 wherein the wallet card activation module further to activate the selected electronic wallet card for a predetermined period of time; and wherein to transfer the electronic card information comprises to transfer the electronic card information corresponding to the selected electronic wallet card only during the predetermined period of time.

In Example 8, the subject matter of any of Examples 1-7 wherein the wallet card selection module further to (i) retrieve electronic card information corresponding to a first electronic wallet card from the wallet card database and (ii) display, on the apparatus, an identification corresponding to the first electronic wallet card; and wherein to receive a selection of one of the plurality of electronic wallet cards comprises to receive a selection of the first electronic wallet card from the plurality of electronic wallet cards stored in the wallet card database.

In Example 9, the subject matter of any of Examples 1-8 wherein the wallet card selection module further to (i) retrieve electronic card information corresponding to a first electronic wallet card from the wallet card database; (ii) display, on the apparatus, an identification corresponding to the first electronic wallet card; (iii) receive a request to display an identification corresponding to a second electronic wallet card stored in the wallet card database; (iv) retrieve the electronic card information corresponding to the second electronic wallet card from the wallet card database; and (v) display, on the apparatus, the identification corresponding to the second electronic wallet card; and wherein to receive a selection of one of the plurality of electronic wallet cards comprises to receive a selection of the second electronic wallet card from the plurality of electronic wallet cards stored in the wallet card database of the apparatus.

In Example 10, the subject matter of any of Examples 1-9 wherein the wallet card synchronization and backup module further to update the electronic card information corresponding to the selected electronic wallet card as a function of the payment transaction.

In Example 11, the subject matter of any of Examples 1-10 wherein to update the electronic card information corresponding to the selected electronic wallet card comprises to reduce a remaining balance of the selected electronic wallet card.

In Example 12, the subject matter of any of Examples 1-11 wherein the wallet card synchronization and backup module further to (i) receive a refill amount for the selected electronic wallet card from at least one of the computing device or the point-of-sale device using the contactless communication mechanism and (ii) increase a remaining balance of the selected electronic wallet card by the refill amount.

In Example 13, the subject matter of any of Examples 1-12 wherein the wallet card synchronization and backup module further to transfer the electronic card information corresponding to the selected electronic wallet card to a remote management server to be backed-up using the computing device as a proxy, the wallet card synchronization and backup module to transfer the electronic card information to the computing device using the contactless communication mechanism and the computing device to forward the electronic card information to the remote management server over a network.

In Example 14, the subject matter of any of Examples 1-13 wherein the wallet card synchronization and backup module further to receive the electronic card information corresponding to the purchased, complimentary, or preloaded gift card from a remote gift card provider server over a network.

In Example 15, the subject matter of any of Examples 1-14 wherein (i) the wallet card synchronization and backup module further to receive electronic wallet data card information from the computing device using the contactless communication mechanism, the electronic wallet data card information corresponding to a wallet data card; (ii) the wallet card database further to store the electronic wallet data card information corresponding to the wallet data card in the wallet card database of the apparatus as an electronic wallet data card, the wallet card database of the apparatus storing a plurality of electronic wallet data cards; (iii) the wallet card selection module further to receive a selection one of the plurality of electronic wallet data cards stored in the wallet card database of the apparatus; and (iv) the wallet card activation module further to display, on the apparatus, the electronic wallet data card information corresponding to the selected electronic wallet card.

Example 16 includes subject matter (such as a system, apparatus, a device, etc.) compromising a processor and a memory having stored therein a plurality of instructions that, in response to being executed by the processor, causes the processor to: receive electronic card information corresponding to a purchased, complimentary, or preloaded gift card from a remote gift card provider server over a network; and transmit the electronic card information corresponding to the purchased, complimentary, or preloaded gift card to an electronic card device using a contactless communication mechanism.

In Example 17, the subject matter of any of Example 16 wherein the contactless communication mechanism comprises near-field communication (NFC) circuitry.

In Example 18, the subject matter of any of Examples 16 or 17, wherein the contactless communication mechanism comprises Bluetooth circuitry.

In Example 19, the subject matter of any of Examples 1.6-18 wherein to transmit electronic card information comprises to transmit at least one of an account number, a purchase date, an expiration date, a merchant name, a purchase amount, an amount last used, and a remaining balance corresponding to the purchased, complimentary, or preloaded gift card.

In Example 20, the subject matter of any of Examples 16-19 wherein further comprising instructions to transmit a refill amount to the electronic card device using the contactless communication mechanism, the refill amount corresponding to a previously transferred gift card on the electronic card device.

In Example 21, the subject matter of any of Examples 16-20 wherein further comprising instructions to: receive electronic card information to be backed up from the electronic card device using the contactless communication mechanism; and transmit the electronic card information to be backed up to a remote management server for storage, the electronic card information to be backed up is transmitted to the remote management server over the network.

In Example 22, the subject matter of any of Examples 16-21 wherein further comprising instructions to secure communications between the computing device and one or more of the remote gift card provider server, the electronic card device, and a remote management server.

In Example 23, the subject matter of any of Examples 16-22 wherein to secure communications comprises to secure communications with one or more encryption keys.

In Example 24, the subject matter of any of Examples 16-23 wherein further comprising instructions to generate a one-time password (OTP) using a Trusted Execution Environment Engine (TEE) for a two-factor authentication procedure.

Example 25 includes subject matter (such as a system, apparatus, a device, etc.) compromising a processor; and a memory having stored therein a plurality of instructions that, in response to being executed by the processor, causes the processor to: receive electronic card information corresponding to a purchased, complimentary, or preloaded gift card from an electronic card device using a contactless communication mechanism for use in a payment transaction; and transmit updated electronic card information corresponding to the purchased, complimentary, or preloaded gift card used in the payment transaction to a remote gift card provider sever or a remote management server over a network for synchronization.

In Example 26, the subject matter of Example 25 wherein the contactless communication mechanism comprises near-field communication (NFC) circuitry.

In Example 27, the subject matter of any of Examples 25 or 26 wherein the contactless communication mechanism comprises Bluetooth circuitry.

In Example 28, the subject matter of any of Examples 25-27 wherein to received electronic card information comprises to receive at least one of an account number, a purchase date, an expiration date, a merchant name, a purchase amount, an amount last used, and a remaining balance corresponding to the purchased, complimentary, or preloaded gift card.

In Example 29, the subject matter of any of Examples 25-28 wherein further comprising instructions to transmit an amount that a remaining balance of the purchased, complimentary, or preloaded gift card used in the payment transaction should be reduced to the electronic card device using the contactless communication mechanism.

In Example 30, the subject matter of any of Examples 25-29 wherein further comprising instructions to transmit a refill amount to the electronic card device using the contactless communication mechanism, the refill amount corresponding to a previously transferred gift card on the electronic card device.

In Example 31, the subject matter of any of Examples 25-30 wherein further comprising instructions to secure communications between the point-of-sale device and one or more of the electronic card device, a gift card provider server, and the remote management server.

In Example 32, the subject matter of any of Examples 25-31 wherein to secure communications comprises to secure communications with one or more encryption keys.

In Example 33, the subject matter of any of Examples 25-32 further comprising instructions to generate a one-time password (OTP) for a two-factor authentication procedure.

Example 34 includes subject matter (such as a system, apparatus, a device, etc.) compromising a processor, and a memory having stored therein a plurality of instructions that, in response to being executed by the processor, causes the processor to: transmit electronic card information corresponding to a purchased, complimentary, or preloaded gift card to a computing device or a point-of-sale terminal over a network; and receive updated electronic card information corresponding to the purchased, complimentary, or preloaded gift card used in a payment transaction from the computing device or the point-of-sale terminal over the network.

In Example 35, the subject matter of Example 34, wherein a data storage device to store the electronic card information corresponding to the purchased, complimentary, or preloaded gift card, the data storage device to store electronic card information corresponding a plurality of purchased, complimentary, or preloaded gift cards.

In Example 36, the subject matter of any of Examples 34 or 35 wherein further comprising instructions to: receive a redemption code corresponding to the purchased, complimentary, or preloaded gift card from the computing device over the network; validate the redemption code corresponding to the purchased, complimentary, or preloaded gift card; and retrieve the electronic card information corresponding to the purchased, complimentary, or preloaded gift card from the data storage device in response to validating the redemption code.

In Example 37, the subject matter of any of Examples 34-36 wherein to transmit electronic card information corresponding to a purchased, complimentary, or preloaded gift card comprises to transmit electronic card information to an electronic card device using the computing device or the point-of-sale terminal as a proxy.

In Example 38, the subject matter of any of Examples 34-37 wherein to transmit electronic card information comprises to transmit at least one of an account number, a purchase date, an expiration date, a merchant name, a purchase amount, an amount last used, and a remaining balance corresponding to the purchased, complimentary, or preloaded gift card.

In Example 39, the subject matter of any of Examples 34-38 wherein further comprising instructions to transmit an amount that a remaining balance of the purchased, complimentary, or preloaded gift card used in the payment transaction should be reduced to an electronic card device using the computing device or the point-of-sale terminal as a proxy.

In Example 40, the subject matter of any of Examples 34-39 wherein further comprising instructions to transmit a refill amount to an electronic card device, the refill amount corresponding to a previously transferred gift card on the electronic card device.

In Example 41, the subject matter of any of Examples 34-40 wherein further comprising instructions to secure communications between the gift card provider device and one or more of the point-of-sale terminal, the computing device, and an electronic card device.

In Example 42, the subject matter of any of Examples 34-41 wherein to secure communications comprises to secure communications with one or more encryption keys.

In Example 43, the subject matter of any of Examples 34-42 wherein further comprising instructions to generate a one-time password (OTP) for a two-factor authentication procedure.

Example 44 includes subject matter (such as a system, apparatus, a device, etc.) compromising a remote gift card provider server to transmit electronic card information corresponding to a purchased, complimentary, or preloaded gift card over a network; a computing device to receive the electronic card information from the remote gift card provider server over the network; and an electronic card device to (i) receive the electronic card information corresponding to the purchased, complimentary, or preloaded gift card from the computing device using a contactless communication interface, (ii) store the electronic card information corresponding to the purchased, complimentary, or preloaded gift card in a secure storage of the electronic card device as an electronic gift card, the secure storage of the electronic card device storing a plurality of electronic gift cards, (iii) receive a selection made on the electronic card device of one of the plurality of electronic gift cards stored in the secure storage, and (iv) transmit the electronic card information corresponding to the selected electronic gift card to a point-of-sale device using the contactless communication interface for a payment transaction.

In Example 45, the subject matter of Example 44 wherein the electronic card device comprises a smartcard.

In Example 46, the subject matter of any of Examples 44 or 45 wherein the electronic card device comprises one of a smart phone, mobile internet device, portable digital assistant, or tablet computer.

In Example 47, the subject matter of any of Examples 44-46 wherein the contactless communication interface comprises a near-field communication (NFC) interface.

In Example 48, the subject matter of any of Examples 44-47, wherein the contactless communication interface comprises a Bluetooth interface.

In Example 49, the subject matter of any of Examples 44-48 wherein the electronic card information comprises at least one of an account number, a purchase date, an expiration date, a merchant name, a purchase amount, an amount last used, and a remaining balance corresponding to the purchased, complimentary, or preloaded gift card.

In Example 50, the subject matter of any of Examples 44-49 wherein the electronic card device further to activate the selected electronic gift card for a predetermined period of time, wherein to transmit the electronic card information comprises to transmit the electronic card information corresponding to the selected electronic gift card only during the predetermined period of time.

In Example 51, the subject matter of any of Examples 44-50 wherein the electronic card device further to (i) retrieve electronic card information corresponding to a first electronic gift card from the secure storage and (ii) display an identification corresponding to the first electronic gift card, wherein the electronic card device to receive a selection of one of the plurality of electronic gift cards comprises to receive a selection of the first electronic gift card from the plurality of electronic gift cards stored in the secure storage of the electronic card device.

In Example 52, the subject matter of any of Examples 44-51 wherein the electronic card device further to (i) retrieve electronic card information corresponding to a first electronic gift card from the secure storage, (ii) display an identification corresponding to the first electronic gift card, (iii) receive a request to display an identification corresponding to a second electronic gift card stored in the secure storage, (iv) retrieve the electronic card information corresponding to the second electronic gift card from the secure storage, and (v) display the identification corresponding to the second electronic gift card stored in the secure storage, wherein the electronic card device to receive a selection of one of the plurality of electronic gift cards comprises to receive a selection of the second electronic gift card from the plurality of electronic gift cards stored in the secure storage of the electronic card device.

In Example 53, the subject matter of any of Examples 44-52 wherein the electronic card device further to update the electronic card information corresponding to the selected electronic gift card as a function of the payment transaction.

In Example 54, the subject matter of any of Examples 44-53 wherein the electronic card device to update the electronic card information corresponding to the selected electronic gift card comprises to reduce a remaining balance of the selected electronic gift card.

In Example 55, the subject matter of any of Examples 44-54 wherein the electronic card device further to (i) receive a refill amount for the selected electronic gift card from at least one of the computing device or the point-of-sale device using the contactless communication interface and (ii) increase a remaining balance of the selected electronic gift card by the refill amount.

In Example 56, the subject matter of any of Examples 44-55 wherein the electronic card device further to transfer the electronic card information corresponding to the selected electronic gift card to the computing device using the contactless communication interface and the computing device further to back up the received electronic card information corresponding to the selected electronic gift card over the network to a remote management server.

In Example 57, the subject matter of any of Examples 44-56 wherein the computing device further to receive the electronic card information corresponding to the purchased, complimentary, or preloaded gift card from the remote gift card provider server over the network.

Example 58 includes subject matter (such as a system, apparatus, a device, etc.) compromising at least one machine readable media comprising a plurality of instructions, which in response to being executed, result in an electronic card device: retrieving electronic card information corresponding to a first electronic gift card stored in a secure storage of the electronic card device, the secure storage of the electronic card device storing a plurality of electronic gift cards; displaying an identification of the first electronic gift card; receiving a signal generated by a push-button switch activated by a user of the electronic card device, the signal generated by activation of the push-button switch indicative of the selection, by the user, of one of the plurality of electronic gift cards stored in the secure storage; and transferring electronic card information corresponding to the selected electronic gift card to a point-of-sale device using a contactless communication interface for a payment transaction.

In Example 59, the subject matter of Example 58 wherein at least one machine readable media of claim 58, wherein the electronic card device comprises a smartcard.

In Example 60, the subject matter of any of Examples 58 or 59 wherein at least one machine readable media of claim 58, wherein the electronic card device comprises one of a smart phone, mobile internet device, portable digital assistant, or tablet computer.

In Example 61, the subject matter of any of Examples 58-60 wherein at least one machine readable media of claim 58, wherein the contactless communication interface comprises a near-field communication (NFC) interface.

In Example 62, the subject matter of any of Examples 58-61 wherein at least one machine readable media of claim 58, wherein the contactless communication interface comprises a Bluetooth interface.

In Example 63, the subject matter of any of Examples 58-62 wherein at least one machine readable media of claim 58, wherein the plurality of instructions further result in the electronic card device: receiving a request to display an identification corresponding to a second electronic gift card stored in the secure storage of the electronic card device; retrieving electronic card information corresponding to the second electronic gift card from the secure storage; and displaying the identification of the second electronic gift card, wherein the signal generated by activation of the push-button switch is indicative of the user selecting the second electronic gift card from the plurality of electronic gift cards stored in the secure storage of the electronic card device.

In Example 64, the subject matter of any of Examples 58-63 wherein at least one machine readable media of claim 58, wherein the plurality of instructions further result in the electronic card device: receiving the electronic card information from a computing device using the contactless communication interface, the electronic card information corresponding to a purchased, complimentary, or preloaded gift card; and storing the electronic card information corresponding to the purchased, complimentary, or preloaded gift card in the secure storage of the electronic card device as an electronic gift card.

Example 65 includes subject matter (such as a system, apparatus, a device, etc.) compromising receiving, on an electronic card device, electronic card information from a computing device using a contactless communication mechanism, the electronic card information corresponding to a purchased, complimentary, or preloaded gift card; storing the electronic card information corresponding to the gift card in a secure storage of the electronic card device as an electronic gift card, the secure storage of the electronic card device to store a plurality of electronic gift cards; receiving, on the electronic card device, a selection of one of the plurality of electronic gift cards stored in the secure storage of the electronic card device, and transferring, by the electronic card device, the electronic card information corresponding to the selected electronic gift card to a point-of-sale device using the contactless communication mechanism for a payment transaction.

In Example 66, the subject matter of Example 65 wherein the electronic card device comprises a smartcard.

In Example 67, the subject matter of any of Examples 65 or 66 wherein the electronic card device comprises one of a smart phone, mobile internet device, portable digital assistant, or tablet computer.

In Example 68, the subject matter of any of Examples 65-67 wherein the contactless communication mechanism comprises near-field communication (NFC) circuitry.

In Example 69, the subject matter of any of Examples 65-68 wherein the contactless communication mechanism comprises Bluetooth circuitry.

In Example 70, the subject matter of any of Examples 65-69 wherein receiving electronic card information from a computing device using a contactless communication mechanism comprises receiving at least one of an account number, a purchase date, an expiration date, a merchant name, a purchase amount, an amount last used, and a remaining balance corresponding to the purchased, complimentary, or preloaded gift card.

In Example 71, the subject matter of any of Examples 65-70 wherein further comprising activating the selected electronic gift card for a predetermined period of time, wherein transferring the electronic card information comprises transferring the electronic card information corresponding to the selected electronic gift card only during the predetermined period of time.

In Example 72, the subject matter of any of Examples 65-71 wherein retrieving electronic card information corresponding to a first electronic gift card from the secure storage; and displaying, on the electronic card device, an identification corresponding to the first electronic gift card, wherein receiving a selection of one of the plurality of electronic gift cards comprises receiving a selection of the first electronic gift card from the plurality of electronic gift cards stored in the secure storage of the electronic card device.

In Example 73, the subject matter of any of Examples 65-72 wherein retrieving electronic card information corresponding to a first electronic gift card from the secure storage; displaying, on the electronic card device, an identification corresponding to the first electronic gift card; receiving, on the electronic card device, a request to display an identification corresponding to a second electronic gift card stored in the secure storage; retrieving the electronic card information corresponding to the second electronic gift card from the secure storage; and displaying, on the electronic card device, the identification corresponding to the second electronic gift card, wherein receiving a selection of one of the plurality of electronic gift cards comprises receiving a selection of the second electronic gift card from the plurality of electronic gift cards stored in the secure storage of the electronic card device.

In Example 74, the subject matter of any of Examples 65-73 wherein further comprising updating, on the electronic card device, the electronic card information corresponding to the selected electronic gift card as a function of the payment transaction.

In Example 75, the subject matter of any of Examples 65-74, wherein updating the electronic card information corresponding to the selected electronic gift card comprises reducing a remaining balance of the selected electronic gift card.

In Example 76, the subject matter of any of Examples 65-75 wherein receiving, by the electronic card device, a refill amount for the selected electronic gift card from at least one of the computing device or the point-of-sale device using the contactless communication mechanism; and increasing, on the electronic card device, a remaining balance of the selected electronic gift card by the refill amount.

In Example 77, the subject matter of any of Examples 65-76 wherein transferring, by the electronic card device, the electronic card information corresponding to the selected electronic gift card to the computing device using the contactless communication mechanism; and backing up, by the computing device, the received electronic card information corresponding to the selected electronic gift card over a network to a remote management server.

In Example 78, the subject matter of any of Examples 65-77 wherein further comprising receiving, by the computing device, the electronic card information corresponding to the purchased complimentary, or preloaded gift card from a remote gift card provider server over a network.

In Example 79, the subject matter of any of Examples 65-78 wherein receiving, on the electronic card device, electronic wallet data card information from the computing device using the contactless communication mechanism, the electronic wallet data card information corresponding to a wallet data card; storing the electronic wallet data card information corresponding to the wallet data card in the secure storage of the electronic card device as an electronic wallet data card, the secure storage of the electronic card device storing a plurality of electronic wallet data cards; receiving, on the electronic card device, a selection one of the plurality of electronic wallet data cards stored in the secure storage of the electronic card device; and displaying, on the electronic card device, the electronic wallet data card information corresponding to the selected electronic wallet card.

Example 80 includes subject matter (such as a system, apparatus, a device, etc.) compromising receiving, on a computing device, electronic card information corresponding to a purchased, complimentary, or preloaded gift card from a remote gift card provider server over a network; and transmitting, by the computing device, the electronic card information corresponding to the purchased, complimentary, or preloaded gift card to an electronic card device using a contactless communication mechanism.

In Example 81, the subject matter of Example 80 wherein the contactless communication mechanism comprises near-field communication (NFC) circuitry.

In Example 82, the subject matter of any of Examples 80 or 81 wherein the contactless communication mechanism comprises Bluetooth circuitry.

In Example 83, the subject matter of any of Examples 80-82 wherein transmitting electronic card information comprises transmitting at least one of an plurality of purchased, complimentary account number, a purchase date, an expiration date, a merchant name, a purchase amount, an amount last used, and a remaining balance corresponding to the purchased, complimentary, or preloaded gift card.

In Example 84, the subject matter of any of Examples 80-83 wherein further comprising transmitting, by the computing device, a refill amount to the electronic card device using the contactless communication mechanism, the refill amount corresponding to a previously transferred gift card on the electronic card device.

In Example 85, the subject matter of any of Examples 80-84 wherein receiving, by the computing device, electronic card information to be backed up from the electronic card device using the contactless communication mechanism; and transmitting, by the computing device, the electronic card information to be backed up to a remote management server for storage, the electronic card information to be backed up is transmitted to the remote management server over the network.

In Example 86, the subject matter of any of Examples 80-85 wherein further comprising securing communications between the computing device and one or more of the remote gift card provider server, the electronic card device, and a remote management server.

In Example 87, the subject matter of any of Examples 80-86 wherein securing communications comprises securing communications with one or more encryption keys.

In Example 88, the subject matter of any of Examples 80-87, wherein further comprising generating, on the computing device, a one-time password (OTP) using a Trusted Execution Environment Engine (TEE) for a two-factor authentication procedure.

Example 89 includes subject matter (such as a system, apparatus, a device, etc.) compromising receiving, by a point-of-sale device, electronic card information corresponding to a purchased, complimentary, or preloaded gift card from an electronic card device using a contactless communication mechanism for use in a payment transaction and transmitting, by the point-of-sale device, updated electronic card information corresponding to the purchased, complimentary, or preloaded gift card used in the payment transaction to a remote gift card provider sever or a remote management server over a network for synchronization.

In Example 90, the subject matter of Example 89 wherein the contactless communication mechanism comprises near-field communication (NFC) circuitry.

In Example 91, the subject matter of any of Examples 89 or 90 wherein the contactless communication mechanism comprises Bluetooth circuitry.

In Example 92, the subject matter of any of Examples 89-91 wherein receiving electronic card information comprises receiving at least one of an account number, a purchase date, an expiration date, a merchant name, a purchase amount, an amount last used, and a remaining balance corresponding to the purchased, complimentary, or preloaded gift card.

In Example 93, the subject matter of any of Examples 89-92 wherein further comprising transmitting, by the point-of-sale device, an amount that a remaining balance of the purchased, complimentary, or preloaded gift card used in the payment transaction should be reduced to the electronic card device using the contactless communication mechanism.

In Example 94, the subject matter of any of Examples 89-93 wherein further comprising transmitting, by the point-of-sale device, a refill amount to the electronic card device using the contactless communication mechanism, the refill amount corresponding to a previously transferred gift card on the electronic card device.

In Example 95, the subject matter of any of Examples 89-94 wherein further comprising securing communications between the point-of-sale device and one or more of the electronic card device, the remote gift card provider server, and the remote management server.

In Example 96, the subject matter of any of Examples 89-95 wherein securing communications comprises securing communications with one or more encryption keys

In Example 97, the subject matter of any of Examples 89-96, wherein further comprising generating, by the point-of-sale device, a one-time password (OTP) for a two-factor authentication procedure.

Example 98 includes subject matter (such as a system, apparatus, a device, etc.) compromising transmitting, by a gift card provider device, electronic card information corresponding to a purchased, complimentary, or preloaded gift card to a computing device or a point-of-sale terminal over a network receiving, by the gift card provider device, updated electronic card information corresponding to the purchased, complimentary, or preloaded gift card used in a payment transaction from the computing device or the point-of-sale terminal over the network.

In Example 99, the subject matter of Examples 98 wherein further comprising storing, on a data storage device of the gift card provider device, the electronic card information corresponding to the purchased, complimentary, or preloaded gift card, the data storage device of the gift card provider device comprises electronic card information corresponding a plurality of purchased, complimentary, or preloaded gift cards.

In Example 100, the subject matter of any of Examples 98 or 99 wherein receiving, by the gift card provider device, a redemption code corresponding to the purchased, complimentary, or preloaded gift card from the computing device over the network; validating, by the gift card provider device, the redemption code corresponding to the purchased, complimentary, or preloaded gift card; and retrieving, by the gift card provider device, the electronic card information corresponding to the purchased, complimentary, or preloaded gift card from the data storage device in response to validating the redemption code.

In Example 101, the subject matter of any of Examples 98-100 wherein transmitting electronic card information corresponding to a purchased, complimentary, or preloaded gift card comprises transmitting electronic card information to an electronic card device using the computing device or the point-of-sale terminal as a proxy.

In Example 102, the subject matter of any of Examples 98-101 wherein transmitting electronic card information comprises transmitting at least one of an account number, a purchase date, an expiration date, a merchant name, a purchase amount, an amount last used, and a remaining balance corresponding to the purchased, complimentary, or preloaded gift card.

In Example 103, the subject matter of any of Examples 98-102 wherein further comprising transmitting, by the gift card provider device, an amount that a remaining balance of the purchased, complimentary, or preloaded gift card used in the payment transaction should be reduced to an electronic card device using the computing device or the point-of-sale terminal as a proxy.

In Example 104, the subject matter of any of Examples 98-103 wherein further comprising transmitting, by the gift card provider device, a refill amount to an electronic card device using the computing device or the point-of-sale terminal as a proxy, the refill amount corresponding to a previously transferred gift card on the electronic card device.

In Example 105, the subject matter of any of Examples 98-104 wherein further comprising securing communications between the gift card provider device and one or more of the point-of-sale terminal, the computing device, and an electronic card device.

In Example 106, the subject matter of any of Examples 98-105 wherein securing communications comprises securing communications with one or more encryption keys.

In Example 107, the subject matter of any of Examples 98-106 wherein further comprising generating, by the gift card provider device, a one-time password (OTP) for a two-factor authentication procedure.

1-107. (canceled)

108. An apparatus comprising:
a wallet card synchronization and backup module to receive electronic card information from a computing device using a contactless communication mechanism, the electronic card information corresponding to a purchased, complimentary, or preloaded gift card;
a wallet card database to store the electronic card information corresponding to the purchased, complimentary, or preloaded gift card as an electronic wallet card, the wallet card database to store a plurality of electronic wallet cards;
a wallet card selection module to receive a selection of one of the plurality of electronic wallet cards stored in the wallet card database; and
a wallet card activation module to transfer the electronic card information corresponding to the selected electronic wallet card to a point-of-sale device using the contactless communication mechanism for a payment transaction.

109. The apparatus of claim 108, wherein the apparatus comprises one of a smartcard, smart phone, mobile internet device, portable digital assistant, or tablet computer, and
wherein the contactless communication mechanism comprises one of near-field communication (NFC) circuitry or Bluetooth circuitry.

110. The apparatus of claim 108, wherein to receive electronic card information from a computing device using a contactless communication mechanism comprises to receive at least one of an account number, a purchase date, an expiration date, a merchant name, a purchase amount, an amount last used, and a remaining balance corresponding to the purchased, complimentary, or preloaded gift card.

111. The apparatus of claim 108, wherein the wallet card activation module further to activate the selected electronic wallet card for a predetermined period of time,
wherein to transfer the electronic card information comprises to transfer the electronic card information corresponding to the selected electronic wallet card only during the predetermined period of time.

112. The apparatus of claim 108, wherein the wallet card selection module further to (i) retrieve electronic card information corresponding to a first electronic wallet card from the wallet card database and (ii) display, on the apparatus, an identification corresponding to the first electronic wallet card,
wherein to receive a selection of one of the plurality of electronic wallet cards comprises to receive a selection of the first electronic wallet card from the plurality of electronic wallet cards stored in the wallet card database.

113. The apparatus of claim 108, wherein the wallet card selection module further to (i) retrieve electronic card information corresponding to a first electronic wallet card from the wallet card database; (ii) display, on the apparatus, an identification corresponding to the first electronic wallet card; (iii) receive a request to display an identification corresponding to a second electronic wallet card stored in the wallet card database; (iv) retrieve the electronic card information corresponding to the second electronic wallet card from the wallet card database; and (v) display, on the apparatus, the identification corresponding to the second electronic wallet card,
wherein to receive a selection of one of the plurality of electronic wallet cards comprises to receive a selection of the second electronic wallet card from the plurality of electronic wallet cards stored in the wallet card database of the apparatus.

114. The apparatus of claim 108, the wallet card synchronization and backup module further to update the electronic card information corresponding to the selected electronic wallet card as a function of the payment transaction.

115. The apparatus of claim 114, wherein to update the electronic card information corresponding to the selected electronic wallet card comprises to reduce a remaining balance of the selected electronic wallet card.

116. The apparatus of claim 108, the wallet card synchronization and backup module further to (i) receive a refill amount for the selected electronic wallet card from at least one of the computing device or the point-of-sale device using the contactless communication mechanism and (ii) increase a remaining balance of the selected electronic wallet card by the refill amount.

117. The apparatus of claim 108, wherein the wallet card synchronization and backup module further to transfer the electronic card information corresponding to the selected electronic wallet card to a remote management server to be backed-up using the computing device as a proxy, the wallet card synchronization and backup module to transfer the electronic card information to the computing device using the contactless communication mechanism and the computing device to forward the electronic card information to the remote management server over a network.

118. The apparatus of claim 108, wherein the wallet card synchronization and backup module further to receive the electronic card information corresponding to the purchased, complimentary, or preloaded gift card from a remote gift card provider server over a network.

119. The apparatus of claim 108, wherein (i) the wallet card synchronization and backup module further to receive electronic wallet data card information from the computing device using the contactless communication mechanism, the electronic wallet data card information corresponding to a wallet data card; (ii) the wallet card database further to store the electronic wallet data card information corresponding to the wallet data card in the wallet card database of the apparatus as an electronic wallet data card, the wallet card database of the apparatus storing a plurality of electronic wallet data cards; (iii) the wallet card selection module further to receive a selection one of the plurality of electronic wallet data cards stored in the wallet card database of the apparatus; and (iv) the wallet card activation module further to display, on the apparatus, the electronic wallet data card information corresponding to the selected electronic wallet card.

120. At least one machine readable media comprising a plurality of instructions, which in response to execution by an electronic card device, cause the electronic card device to:
retrieve electronic card information corresponding to a first electronic gift card stored in a secure storage of the electronic card device, the secure storage of the electronic card device storing a plurality of electronic gift cards;
display an identification of the first electronic gift card;
receive a signal generated by a push-button switch activated by a user of the electronic card device, the signal generated by activation of the push-button switch indicative of the selection, by the user, of one of the plurality of electronic gift cards stored in the secure storage; and
transfer electronic card information corresponding to the selected electronic gift card to a point-of-sale device using a contactless communication interface for a payment transaction.

121. The at least one machine readable media of claim 120, wherein the electronic card device comprises one of a smartcard, smart phone, mobile internet device, portable digital assistant, or tablet computer; and
wherein the contactless communication interface comprises one of a near-field communication (NFC) interface or a Bluetooth interface.

122. The at least one machine readable media of claim 120, wherein the plurality of instructions further cause the electronic card device to activate the selected electronic gift card for a predetermined period of time,
wherein to transfer the electronic card information comprises to transfer the electronic card information corresponding to the selected electronic gift card only during the predetermined period of time.

123. The at least one machine readable media of claim 120, wherein the plurality of instructions further cause the electronic card device to:
receive a request to display an identification corresponding to a second electronic gift card stored in the secure storage of the electronic card device;
retrieve electronic card information corresponding to the second electronic gift card from the secure storage; and
display the identification of the second electronic gift card,
wherein the signal generated by activation of the push-button switch is indicative of the user selecting the second electronic gift card from the plurality of electronic gift cards stored in the secure storage of the electronic card device.

124. The at least one machine readable media of claim 120, wherein the plurality of instructions further cause the electronic card device to:
receive the electronic card information from a computing device using the contactless communication interface, the electronic card information corresponding to a purchased, complimentary, or preloaded gift card; and
store the electronic card information corresponding to the purchased, complimentary, or preloaded gift card in the secure storage of the electronic card device as an electronic gift card.

125. A method comprising:
receiving, on an electronic card device, electronic card information from a computing device using a contactless communication mechanism, the electronic card information corresponding to a purchased, complimentary, or preloaded gift card;
storing the electronic card information corresponding to the gift card in a secure storage of the electronic card device as an electronic gift card, the secure storage of the electronic card device to store a plurality of electronic gift cards;
receiving, on the electronic card device, a selection of one of the plurality of electronic gift cards stored in the secure storage of the electronic card device;
transferring, by the electronic card device, the electronic card information corresponding to the selected electronic gift card to a point-of-sale device using the contactless communication mechanism for a payment transaction; and
updating, on the electronic card device, the electronic card information corresponding to the selected electronic gift card as a function of the payment transaction.

126. The method of claim 125, further comprising:
retrieving electronic card information corresponding to a first electronic gift card from the secure storage; and
displaying, on the electronic card device, an identification corresponding to the first electronic gift card,
wherein receiving a selection of one of the plurality of electronic gift cards comprises receiving a selection of the first electronic gift card from the plurality of electronic gift cards stored in the secure storage of the electronic card device.

127. The method of claim 125, further comprising:
retrieving electronic card information corresponding to a first electronic gift card from the secure storage;
displaying, on the electronic card device, an identification corresponding to the first electronic gift card;
receiving, on the electronic card device, a request to display an identification corresponding to a second electronic gift card stored in the secure storage;
retrieving the electronic card information corresponding to the second electronic gift card from the secure storage; and
displaying, on the electronic card device, the identification corresponding to the second electronic gift card,
wherein receiving a selection of one of the plurality of electronic gift cards comprises receiving a selection of the second electronic gift card from the plurality of electronic gift cards stored in the secure storage of the electronic card device.
